(19) United States
(12) Patent Application Publication
(10) Pub. No.: US 2022/0004440 A1
(43) Pub. Date: Jan. 6, 2022

(54) OPTIMIZATION OF VIRTUAL AGENT UTILIZATION

(71) Applicant: INTERNATIONAL BUSINESS MACHINES CORPORATION, ARMONK, NY (US)

(72) Inventors: Gandhi Sivakumar, Bentleigh (AU); Salil Ahuja, Madison, WI (US); Debojyoti Mookerjee, Normanhurst (AU); Anand Shantilal Borse, Glen Huntly (AU)

(21) Appl. No.: 16/946,683

(22) Filed: Jul. 1, 2020

(51) Int. Cl. G06F 9/50; G06F 9/451; G06F 9/48

(52) U.S. Cl. CPC G06F 9/5083; G06F 9/453; G06F 9/4862; G06F 9/505; G06F 9/5022

(57) ABSTRACT

An approach to optimizing utilization of virtual agents within a virtual agent system. The approach may include monitoring the processing loads of virtual agents and identifying highly utilized virtual agents. The approach may also include configuring a pathway which directs a user query to the identified highly utilized virtual agent and allowing the highly utilized virtual agent to respond to the user query if the highly utilized virtual agent is capable of generating a satisfactory response. Additionally, the approach may include sending the user query to one or more other virtual agents if the highly utilized virtual agent is unable to generate a response above a confidence threshold.

### BACKGROUND

The present disclosure relates generally to virtual agents and more specifically, to optimization of virtual agent utilization through dynamically directing user input queries to more highly utilized virtual agents.

Artificial intelligent systems solve a variety of problems and one such is virtual agents simulating humans. Virtual agents can be deployed to aid users. Virtual agents can accept in-bound queries from users. A typical virtual agent has nodes or processing units which receive the incoming user queries and respond with labels or entities above a respective confidence threshold. The processing required at each node involves various associated costs.

### SUMMARY

Embodiments of the present disclosure include a method, computer program product, and system for optimizing virtual agent utilization. A processor can monitor processing loads of virtual agents. The processor can determine if a processing load of a first virtual agent of the virtual agents is above a first threshold. If responsive to determining the processing load of the first virtual agent is above the first threshold, a processor can configure a pathway to direct an incoming user query to the first virtual agent.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram generally depicting a virtual agent utilization optimization environment, in accordance with an embodiment of the present invention.

FIG. 2 is a functional block diagram depicting a virtual agent utilization optimization engine, in accordance with an embodiment of the present invention.

FIG. 3 is a flowchart depicting operational steps of an approach to optimize virtual agent utilization, in accordance with an embodiment of the present invention.

FIG. 4 is a flowchart depicting operational steps of an approach to optimize virtual agent utilization, in accordance with an embodiment of the present invention.

FIG. 5 is a block diagram depicting layers of abstraction within the optimization of virtual agent utilization environment, in accordance with an embodiment of the present invention.

FIG. 6 is a block diagram of an exemplary computer system suited for implementing the virtual agent utilization optimization approach, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted and described herein recognize the need to optimize resource utilization in virtual agent systems. Further, user queries can be dynamically directed to highly utilized virtual agents, rather than transmitting a user query to all of the virtual agents in a system. The embodiments depicted and described herein recognize the benefits of monitoring a system of virtual agents and configuring a pathway to direct a user query to a virtual agent that is experiencing high utilization, thus reducing the resources required to operate the virtual agent system.

In one embodiment of the invention, a virtual agent optimization engine can monitor the processing utilization of multiple virtual agent nodes. Once a virtual agent with high processing utilization has been identified, a pathway can be configured to direct user queries directly to the highly utilized virtual agent node, bypassing the other virtual agent nodes within the system.

An example of an embodiment with a configured pathway can be creating a replica node of the highly utilized virtual agent within an ephemeral layer. An ephemeral layer is a virtual layer above the operational layer in which the virtual agents in a virtual agent system are operational. All user queries are directed to the replica node within the ephemeral layer. The replica node within the ephemeral layer can determine if it is able to respond to the user query with confidence above a predetermined threshold.

In another embodiment of the invention, a module can configure a pointer to be the pathway in which all user queries are directed to the identified highly utilized node. Further, the highly utilized node can determine if it is able to respond to the user query with confidence above a predetermined threshold.

In yet another embodiment of the invention, if the highly utilized node is unable to respond to a user query, the user query can be sent to the other virtual agents within the system.

An example of an embodiment may be an automated call center in which a program monitors multiple virtual agents that are configured to answer questions about a specific topic, for example troubleshooting software, tracking packages, tracking shipments, etc. The program can determine which virtual agent has a high utilization and can configure incoming user queries to be directed to the virtual agent with high utilization. High utilization in this context can be the utilization of processor consumption, memory consumption, power consumption, etc., or a combination of utilization of computing resources above a predetermined threshold. For example, a replica node can be created to receive user queries within an ephemeral layer. The virtual agent can determine if it is able to respond to a user query with high confidence, i.e., above a predetermined threshold. If the virtual agent determines it can respond to the user query, then it can either send a response from the replica node that received the user query, or it can send the user query to the parent node from which it was replicated in the operational layer. If the replica node determines it is unable to respond to the user query with a response above a predetermined confidence threshold, the user query can be sent to other virtual agents within the system (i.e. the non-replicated virtual agents).

In another embodiment, a module can monitor the highly utilized virtual agent that has been configured to receive incoming user queries. If the module determines the utilization of the virtual agent configured to receive user queries falls below a threshold, the configuration can be recycled, thus not directing user queries to be directed to the virtual agent. The configuration is the pathway which directs the incoming user query to the highly utilized virtual agent. Further, the module that monitors the utilization of all the virtual agents can continue to monitor the virtual agents.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure or characteristic in connection with an embodiment, one skilled in the art has the knowledge to affect such feature, structure or characteristic in connection with other embodiments whether or not explicitly described.

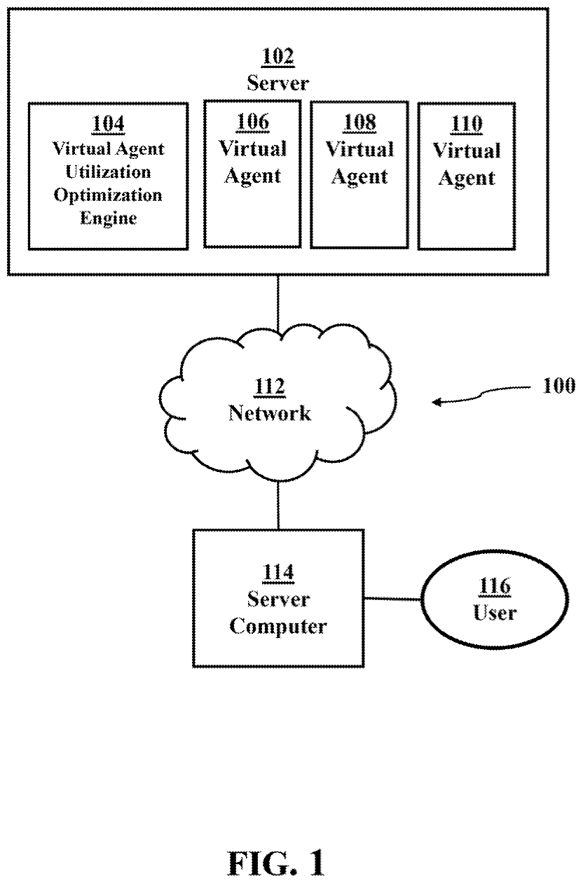

FIG. 1 is a functional block diagram illustrating, generally, an embodiment of a virtual agent utilization optimization environment 100. The virtual agent utilization optimization environment 100 comprises virtual agent utilization optimization engine (VAUOE) 104, virtual agent 106, virtual agent 108, and virtual agent 110, operational on server 102, server computer 114, user 116 and network 112 supporting communications between server 102, and server computer 114. It should be noted while three virtual agents 106, 108 and 110 are shown in FIG.1, there can be any number of virtual agents within virtual agent utilization optimization environment 100 (e.g. 1, 2, 3, . . . n).

Server 102 and server computer 114 can be standalone computing device, management server, a web server, a mobile computing device, or any other electronic device or computing system capable of receiving, sending, and processing data. In other embodiments, server 102 and server computer 114 can represent a server computing system utilizing multiple computers as a server system. In another embodiment, server 102 and server computer 114 can be a laptop computer, a tablet computer, a netbook computer, a personal computer, a desktop computer, or any programmable electronic device capable of communicating with other computing devices (not shown) within virtual agent utilization optimization environment 100 via network 112.

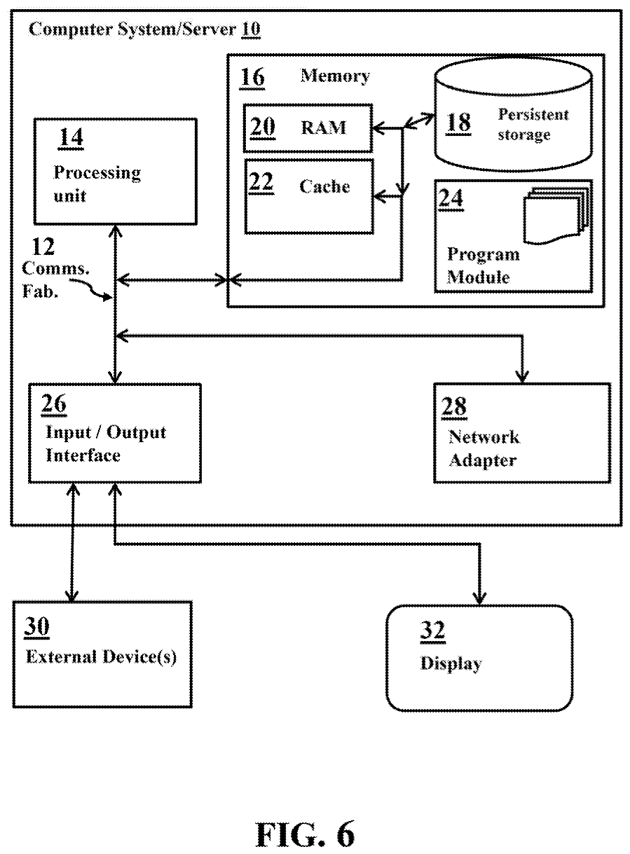

In another embodiment, server 102 and server computer 114 can represent a computing system utilizing clustered computers and components (e.g., database server computers, application server computers, etc.) that act as a single pool of seamless resources when accessed within virtual agent utilization optimization environment 100. Server 102 and server computer 114 can include internal and external hardware components, as depicted and described in further detail in FIG. 6.

Network 112 can be, for example, a local area network (LAN), a wide area network (WAN) such as the Internet, or a combination of the two, and can include wired, wireless, or fiber optic connections. In general, network 112 can be any combination of connections and protocols that will support communications between server 102 and server computer 114.

VAUOE 104 can be operational on server 102. VAUOE 104 can provide the capability to monitor the processing demands of virtual agents. Processing in this sense can include, but is not limited to, power consumption, computer processing unit utilization, network utilization, computing resource utilization, time period in which one or more users is engaged with a virtual agent. Further, VAUOE 104 can provide the capability to configure user queries to be sent to a specific virtual agent. In some embodiments, VAUOE 104 can provide the capability to continuously monitor the processing demands of a virtual agent that has been configured to receive user queries. In other embodiments, VAUOE 104 can provide the capability to remove the configuration which sends incoming user queries to the highly utilized virtual agent. It should be noted, the configuration is the manner in which the incoming queries are directed to the highly utilized virtual agent (e.g.an ephemeral layer, query funnel, etc.)

Multiple virtual agents 106, 108, 110 can be operational on server 102. FIG. 1 depicts virtual agent 106, virtual agent 108, and virtual agent 110. Virtual agents 106, 108, 110 can be modules that receive user queries and provide responses above a predetermined confidence threshold. It should be noted, virtual agents 106, 108, 110 make up a virtual agent system. A virtual agent system can be one or more virtual agents operational on a computing device and utilizing shared computing resources. For example, a virtual agent may be part of a program within a call center and receive user queries via an utterance from a user. The responses from the virtual agents can be auditory, text, or visual in nature (e.g. pictures or moving objects). In another example, the virtual agent may be a chatbot that receives written queries from a user and responds with text, pictures, or video. It should be noted, while FIG. 1 depicts three separate virtual agents, virtual agent utilization optimization environment 100 can include any number of virtual agents to comprise a virtual agent system (e.g. 1, 2, n . . . n+1).

While VAUOE 104 is shown on server 102 with virtual agents 106, 108, 110, VAUOE 104 can be located on a separate server from virtual agent 106, virtual agent 108 and virtual agent 110, or can be located on a server with one or more of virtual agents 106, 108, 110, in any combination. Further, virtual agents 106, 108, 110 are not required to be operational on the same server and can be operational on multiple servers, in any combination.

User 116 can access the system by any input/output device capable of inputting a query. Further, user 116 can access the virtual agents 106, 108, 110 by telephone (e.g. landline, cellular network, or voice over internet protocol), internet (e.g. chatbot, e-mail, instant messaging), or local area network.

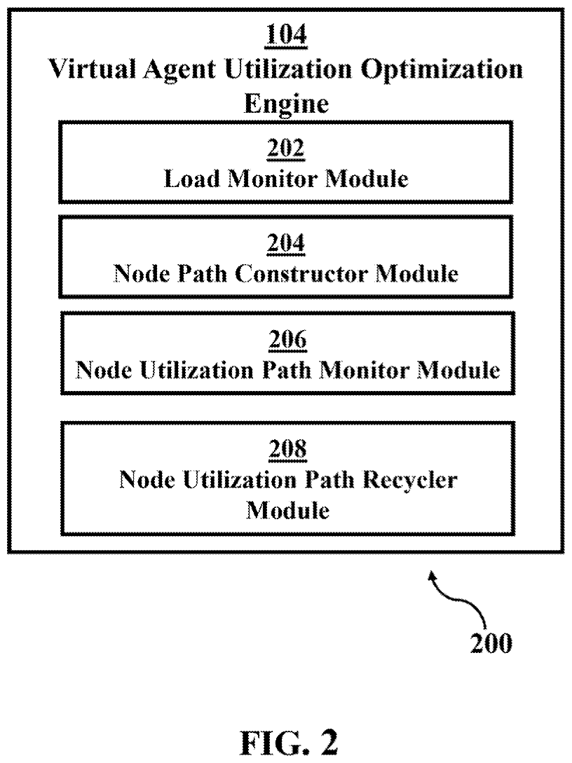

Now with reference to FIG. 2, illustrated is a block diagram of VAUOE 104 further comprising load monitor module 202, node path constructor module 204, node utilization path monitor module 206 and node utilization path recycler module 208 operational on VAUOE 104.

Load monitor module 202, of an embodiment of the present invention, can provide the capability to monitor the resource utilization of virtual agents within a virtual agent system. In some embodiments, load monitor module 202 can monitor virtual agent 106, 108, 110 utilization of computer processing unit(s), network 112, power consumption, graphics processing unit, memory consumption, and/or duration of time a user is engaged with a virtual agent. Load monitor module 202 can monitor the processing utilization of virtual agents in series or in parallel. Load monitor module 202 can monitor the resource utilization virtual agent of a virtual agent system for the above referenced factors and create a resource utilization score. A resource utilization score can be a determined by monitoring the resource usage of virtual agents within a virtual agent system and assigning weights to the resource.

Node path constructor module 204, of an embodiment of the present invention, can configure a path directing a user query to an identified highly utilized virtual agent. Additionally, in an embodiment, node path constructor module can orchestrate the transmission of the user query to one or more virtual agents within the virtual agent system, if the highly utilized virtual agent the user query was initially directed to determines it is unable to respond to the user query above a confidence threshold. Node path constructor module 204 can receive the information collected by load monitor module 202 and determine whether the resource utilization of a virtual agent reaches a threshold (predetermined or dynamically determined). Further, node path constructor module 204 can configure a path for a user query to be directed to a virtual agent that exceeds a resource utilization threshold. The user query path can be configured in numerous ways, for example, node path constructor module 204 can create a replica of any of the virtual agent within a virtual agent system that exceeds the resource utilization threshold in an ephemeral layer. The ephemeral layer can be a virtual layer above the operational base virtual agent system. In other words, it can be a virtualization layer above the operating system (OS) running the virtual agent system. Node path constructor module 204 can configure the path to allow the replicated virtual agent to respond to a user query, if the replicated virtual agent can respond above a predetermined threshold confidence. A replicated virtual agent is the highly utilized agent identified in the virtual agent system. Additionally, node path constructor module 204 can receive a notification from the replicated virtual agent, if the replicated virtual agent determines it is unable to respond to a user query above a predetermined confidence threshold. Node path constructor module 204, can then orchestrate the transmission of the user query to the virtual agents that were not replicated within the ephemeral layer, but still operational within the OS.

In another example, node path constructor module 204 can create a query funnel which can direct the transmission of the user query directly to the identified highly utilized virtual agent, identified by load monitor module 202. The query funnel can be the suspension of the other virtual agents, for example, it can create a partition only allowing the identified highly utilized virtual agent to be operational within the virtual agent system or taking the other virtual agents off-line and only executing the other virtual agents when the highly utilized virtual agent is unable to respond to a user query above the confidence threshold. Further, if the identified virtual agent is unable to respond to the user query above a predetermined confidence level, node path constructor module 204 can orchestrate the transmission of the user query to other virtual agents within the virtual agent system. For example, by terminating the suspension of the other virtual agents (e.g. by removing the partition.)

Node utilization path monitor module 206, can monitor the configured path traffic of incoming queries and the processing utilization of the virtual agent identified as a high utilization virtual agent by load monitor module 202. In an embodiment, node utilization path monitor module 206 can monitor the system resources used by the identified virtual agent and determine if the system resources fall below a predetermined level. For example, if the identified virtual agent is unable to respond to the incoming user queries within a predetermined confidence threshold, the processing requirements of the virtual agent may fall below the predetermined threshold. In another embodiment, node utilization path monitor module 206 can determine the number of user queries the identified virtual agent has responded to and the number of user queries which were transmitted to the other virtual agents because the user queries the identified virtual agent can respond to falls below a predetermined threshold (for example 85%).

Node utilization path recycler module 208 can provide the capability to recycle the path configured to send user queries to the identified virtual agent utilizing high resources. In some embodiments, node utilization path recycler module 208 receives a command from node utilization path monitor module 206 directing node utilization path recycler module 208 to remove the replica virtual agent from the ephemeral layer and/or to remove the ephemeral layer.

In other embodiments, node utilization path recycler module 208 can receive a command from node utilization path monitor module 206 to remove the query funnel directing all user queries to the identified highly utilized virtual agent 106, 108, 110. In yet another embodiment, node utilization path recycler module 208 can reset the orchestration of incoming user queries to allow user queries to be sent to all virtual agents within the virtual agent system or to specific virtual agents within the virtual agent system (e.g. virtual agents with regular historical usage).

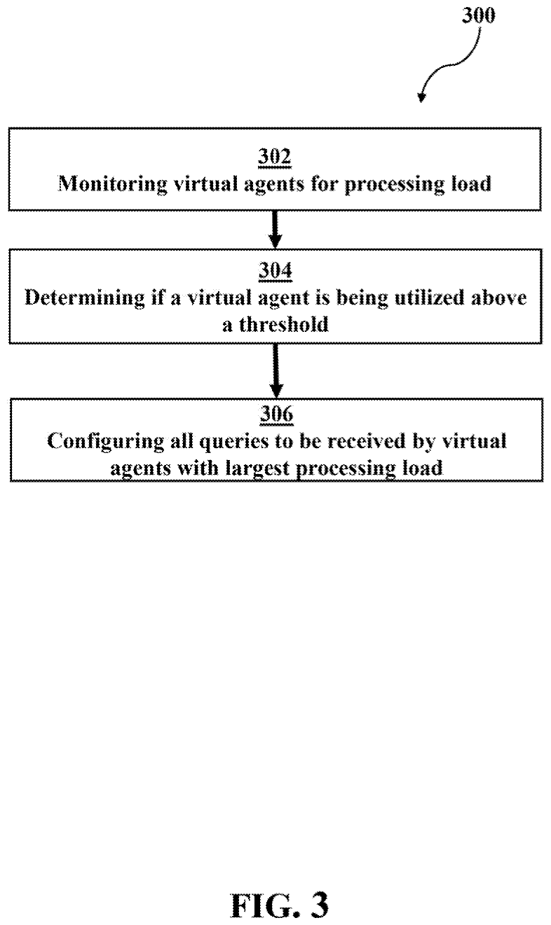

FIG. 3 is a flowchart depicting the operational steps of optimization of virtual agent utilization method 300, according to an embodiment of the present invention. At step 302, processing loads of virtual agents are monitored via load monitor module 202. Next, at step 304, identify a virtual agent with a processing load above a predetermined threshold via node path constructor module 204 based on the monitoring. Next, at step 306, configure a path to transmit incoming user queries to the identified virtual agent with the processing load above a threshold via node path constructor module 204.

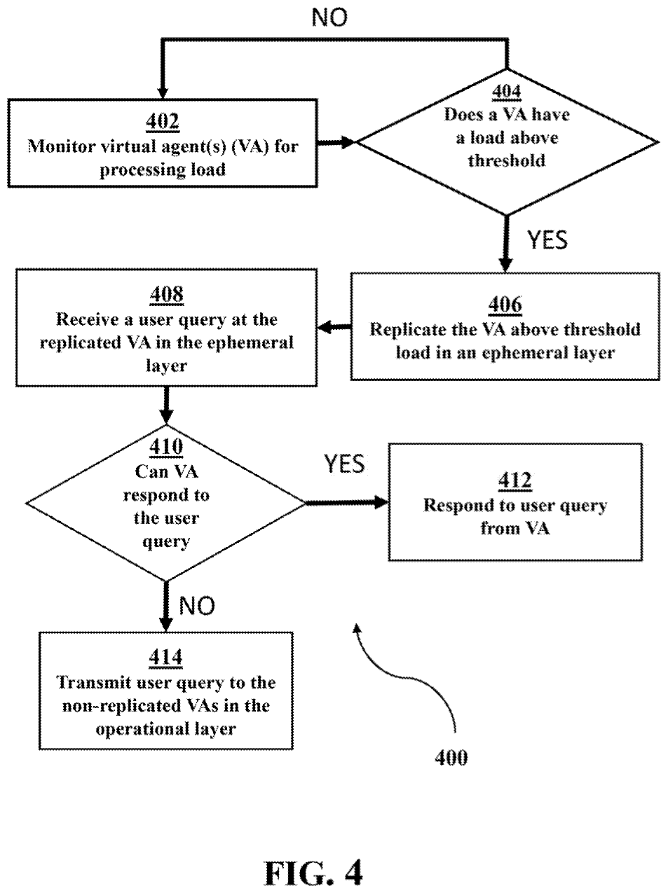

FIG. 4 is a flowchart depicting the operational steps of optimization of virtual agent utilization method 400, according to an embodiment of the present invention. At step 402, monitor the virtual agents for processing load using load monitor module 202. Next, at step 404 determine if any of the virtual agents has a processing load above a threshold using node path constructor module 204. If none of the virtual agents have a processing load above the threshold, return to step 402. If any of the virtual agents has a load above a threshold, proceed to step 406. Next, at step 406, replicate the virtual agent, with the processing load above the threshold, to an ephemeral layer with node path constructor module 204. Next, at step 408, receive a user query at the replicated node in the ephemeral layer. Next, at step 410 determine if the replicated virtual agent can respond to the user query using node utilization path monitor module 206. If the replicated virtual agent can respond to the user query, continue to step 412. If the replicated virtual agent is unable to respond to the user query, continue to step 414. At step 412, the replicated virtual agent responds to the user query. At step 414, transmit the user query to the non-replicated virtual agent s within the original system layer using node path utilization monitor module 206.

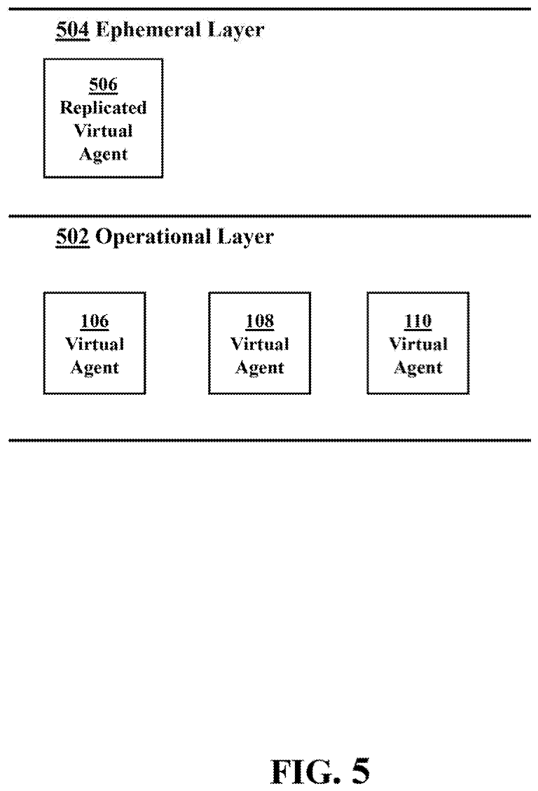

FIG. 5 is a block diagram depicting abstract layers within the optimization of virtual agent utilization environment 100, including virtual agent 106, virtual agent 108 and virtual agent 110 operational within operational layer 502, and Replicated virtual agent 506 operational within ephemeral layer 504. It should be noted that FIG. 5 is an example of an embodiment after it has been identified virtual agent is as a highly utilized virtual agent and replicated by node path constructor module 204.

FIG. 6 depicts computer system 10, which is representative of a device within virtual agent utilization optimization environment 100. Computer system 10 includes communications fabric 12, which provides communications between computer processor(s) 14, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Memory 16 and persistent storage 18 are computer readable storage media. In this embodiment, memory 16 includes random access memory (RAM) 20. In general, memory 16 can include any suitable volatile or non-volatile computer readable storage media. Cache 22 is a fast memory that enhances the performance of processors 14 by holding recently accessed data, and data near recently accessed data, from memory 16.

Program instructions and data used to practice embodiments of the present invention may be stored in persistent storage 18 and in memory 16 for execution by one or more of the respective processors 14 via cache 22. In an embodiment, persistent storage 18 includes a magnetic hard disk drive. Alternatively, or in addition to a magnetic hard disk drive, persistent storage 18 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Network adaptor 28, in these examples, provides for communications with other data processing systems or devices. In these examples, network adaptor 28 includes one or more network interface cards. Network adaptor 28 may provide communications through the use of either or both physical and wireless communications links. Program instructions and data used to practice embodiments of the present invention may be downloaded to persistent storage 18 through network adaptor 28.

I/O interface(s) 26 allows for input and output of data with other devices that may be connected to each computer system. For example, I/O interface 26 may provide a connection to external devices 30 such as a keyboard, keypad, a touch screen, and/or some other suitable input device. External devices 30 can also include portable computer readable storage media such as, for example, thumb drives, portable optical or magnetic disks, and memory cards. Software and data used to practice embodiments of the present invention can be stored on such portable computer readable storage media and can be loaded onto persistent storage 18 via I/O interface(s) 26. I/O interface(s) 26 also connect to display 32.

Display 30 provides a mechanism to display data to a user and may be, for example, a computer monitor or projector.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for optimizing virtual agent utilization, the method comprising:
monitoring, by one or more processors, processing loads of virtual agents;
determining, by the one or more processors, if a processing load of a first virtual agent of the virtual agents is above a first threshold; and
responsive to determining the processing load of the first virtual agent is above the first threshold, configuring, by the one or more processors, a pathway to direct an incoming user query to the first virtual agent.

2. The computer-implemented method of claim 1, further comprising:
receiving, by the one or more processors, a user query; and
determining, by the one or more processors, if the first virtual agent can generate a response to the user query above a predetermined confidence threshold.

3. The computer-implemented method of claim 2, further comprising:
responsive to determining the first virtual agent can generate a response to the user query above a predetermined confidence threshold, generating, by the one or more processors, a response to the user query by the first virtual agent; and
sending, by the one or more processors, the response to the user.

4. The computer-implemented method of claim 2, further comprising:
responsive to determining the virtual agent with the processing load above the threshold cannot generate a response to the user query above a predetermined confidence threshold, sending, by the one or more processors, the user query to the virtual agent of the at least two virtual agents not configured to receive the user query.

5. The computer-implemented method of claim 1, wherein the pathway is replicating the first virtual agent within an ephemeral layer.

6. The computer-implemented method of claim 1, wherein the pathway is creating a query funnel to the first virtual agent.

7. The computer-implemented method of claim 1, further comprising:
monitoring, by the one or more processors, the processing load of the first virtual agent;
determining, by the one or more processors, if the processing load of the first virtual agent falls below a second threshold; and
responsive to determining the processing load of the first virtual agent falls below a second threshold, recycling, by the one or more processors, the pathway.

8. A computer program product comprising a computer readable storage medium having program instructions embodied therewith, the program instructions executable by a processor to cause the processors to perform a function, the function comprising:
monitor processing loads of virtual agents;
determine if the processing load of a first virtual agents is above a first threshold; and
responsive to determining the processing load of the first virtual agent is above the first threshold, configuring a pathway to direct an incoming user query to the first virtual agent.

9. The computer program product of claim 8, further comprising:
receive a user query; and
determine if the first virtual agent can generate a response to the user query above a predetermined confidence threshold.

10. The computer program product of claim 9, further comprising:
responsive to determining the first virtual agent can generate a response to the user query above a predetermined confidence threshold, generate a response to the user query by the first virtual agent; and
sending the response to the user.

11. The computer program product of claim 9, further comprising:
responsive to determining if the first virtual agent cannot generate a response to the user query above a predetermined confidence threshold, send the user query to at least a second virtual agent, not configured to initially receive the user query via the pathway.

12. The computer program product of claim 8, wherein the pathway is replicating the first virtual agent within an ephemeral layer.

13. The computer program product of claim 8, wherein the pathway is creating a query funnel to the first virtual agent.

14. The computer program product of claim 8, further comprising:
monitoring the processing load of the first virtual agent;
determining if the processing load of the first virtual agent falls below a second threshold; and
responsive to determining the processing load of the first virtual agent falls below a second threshold, recycling the pathway.

15. A system comprising:
a memory; and
a processor in communication with the memory, the processor being configured to perform operations comprising:
monitor processing loads of virtual agents;
determine if the processing load of a first virtual agents is above a first threshold; and
responsive to determining the processing load of the first virtual agent is above the first threshold, configuring a pathway to direct an incoming user query to the first virtual agent.

16. The system of claim 15, wherein the operations further comprise:
responsive to determining the first virtual agent can generate a response to the user query above a predetermined confidence threshold, generate a response to the user query by the first virtual agent; and
sending the response to the user.

17. The system of claim 16, further comprising:
responsive to determining if the first virtual agent cannot generate a response to the user query above a predetermined confidence threshold, send the user query to at least a second virtual agent, not configured to initially receive the user query via the pathway.

18. The system of claim of claim 16, wherein the operations further comprise:
further comprising:
if not responsive to determining if the virtual agent with the processing load above the threshold can generate a response to the user query above a predetermined confidence threshold, send, by the one or more processors, the user query to the virtual agent of the at least two virtual agents not configured to receive the user query.

19. The system of claim 15, wherein the pathway is replicating the first virtual agent within an ephemeral layer.

20. The system of claim 15, further comprising:
monitoring the processing load of the first virtual agent;
determining if the processing load of the first virtual agent falls below a second threshold; and
responsive to determining the processing load of the first virtual agent falls below a second threshold, recycling the pathway.
